(19) United States
(12) Patent Application Publication
(10) Pub. No.: US 2007/0109185 A1
(43) Pub. Date: May 17, 2007

(54) Providing GPS pseudo-ranges

(76) Inventors: Doug Kracke, Tempe, AZ (US); Jim Stephen, Phoenix, AZ (US)

Correspondence Address: MOTOROLA, INC., 1303 EAST ALGONQUIN ROAD, IL01/3RD, SCHAUMBURG, IL, 60196, US

(21) Appl. No.: 11/273,456

(22) Filed: Nov. 14, 2005

(51) Int. Cl. G01S 5/14

(52) U.S. Cl. 342/357.09

(57) ABSTRACT

A vehicle location determination system and method includes a vehicle-mounted position determining system, including a computer for executing position determining software, and at least one aiding data source such as a global positioning system (GPS) receiver, an odometer, gyroscope, a short-range radio link or a map database. In response to a request by a position determining entity (PDE) or other requesting entity a response is provided, which may include a computed pseudo-range to one or more GPS satellites.

### TECHNICAL FIELD

The present application relates to vehicular position determination, and more particularly to a response to a position determination request.

### BACKGROUND

In an effort to provide better responsiveness to emergency situations, governmental entities have established telephone answering centers with rapid communication to the emergency services such as police, fire and ambulance, typically with a dedicated telephone number. In the United States, this number is being standardized as 911, and this number will be used to represent such a service.

Telephone calls made to 911 from mobile communications devices such as cellular telephones present a problem to the 911 personnel as the telephone number of a mobile device does not have a unique relationship to the location of the device at any particular time. In view of the roaming features of the cellular telephone network and the Internet, the position or geographic location of the telephone from which the call is being made cannot be determined by associating a calling telephone number with a street address, as would be possible for a conventional wire-line telephone. As the frequency of cellular telephone calls to 911 has increased, reporting traffic accidents and other emergencies, the difficulty in determining the location of the caller has also increased. This has led to a mandate by the United States Federal Communications Commission that cellular telephone systems operators (“system operators”) be able to provide a geo-location of each cellular telephone making a call to 911. This is termed Enhanced 911 or E911 service.

At present, there are two basic approaches being taken to fulfill the E911 mandate. In one approach, the location of the cellular telephone is determined by making measurements on the signal emitted by the cellular telephone, either by measuring the time-difference of arrival (TDOA) of the signal at three or more cell base stations and using hyperbolic navigation solutions, or by measuring the angle of arrival (AOA) of the signals at three or more cell base stations and using triangulation. A combination of these two techniques may also be used.

In another approach, the location of the cellular telephone is determined by trilatteration of satellite-based radio navigation signals. Systems for position, velocity and time (PVT) determination have become available, such as the Global Positioning System (GPS) and the Global Navigation Satellite System (GLONASS) operated by the Russian Federation, and other proposed Global Navigation Satellite Systems (GNSS) proposed for future deployment. With the aid of such systems, the location of a mobile or portable station can be determined with precision, anywhere on or above the surface of the earth. The term GPS is used to represent GPS, GLONASS and GNSS as well as any other satellite-based navigation system. Further details on GPS may be found in ICD-GPS-200C, Navstar GPS Space Segment/Navigation User Interfaces, September 1997 (ARINC Research Corporation, El Segundo, Calif.).

The Telecommunications Industries Association has published a specification standard for messages that may be exchanged between position determining entities (PDE) and a cellular telephone so that the PDE may support a 911 center with a geographic location of the cellular telephone making an emergency call. This specification, TIA/EIA/IS-801-1 (available from Global Engineering Documents, Englewood, CO) represents an industry consensus and is expected to be used, although such use is not mandatory. Not all of the messages defined in the protocol are expected to be used by any PDE, and it is expected that the subset being implemented in any particular time frame would depend on agreements between the cellular telephone manufacturers, the systems operators and the PDE operators.

All of the GPS-type systems suffer from signal blockage problems. The signals propagating from the satellites to a receiver travel on an essentially line-of-sight path and are not capable of penetrating a significant distance through or into structures such as buildings due to the propagation characteristics of the portion of the radio frequency spectrum being used. Additionally, the accuracy of the measurements is influenced by multi-path, which is the reflection of the signals from objects, such as buildings, and which lengthens the path of the signal between the satellite and the receiver. For a number of technical reasons, the signal power at the receiver is low, and this can also contribute to errors in measurement and resultant position determination.

In view of the problems with the use of GPS, such as those described above, it is not always possible to obtain data sufficient to compute the range to three or more satellites, and the PDE must resort to the use of much less accurate estimators of the cellular telephone location. Such a situation can occur when the cellular telephone is in an area of tall buildings (the “urban canyon” effect), in an underground parking garage or tunnel, and sometimes in heavily forested areas. At times, no GPS signals are received due to these problems, yet cellular telephone communications is possible.

In practice, GPS receivers measure the pseudo-range to each of the satellites which can be received. The term pseudo-range is used to indicate that the clock time at the receiver differs from that of each of the satellites by a clock offset value that represents the relative clock drift due to a difference in the oscillation frequency used to estimate time at each satellite and at the receiver. At present, sufficiently accurate clocks are not yet practical for low cost receivers. When a fourth GPS satellite signal can be received, however, the clock offset value can be determined and a navigation solution computed.

Some mobile systems mitigate the unreliability of reception of GPS signals by providing auxiliary means of navigation for time periods where there is a GPS outage or, more generally, provide a hybrid navigation solution, which may combine the GPS data with aiding devices such as: odometer data, automatic braking system (ABS) data, gyroscope data, magnetic compass data, or the like. These diverse sources of information may be combined in a filtering technique, such as a Kalman filter, although other position estimation algorithms may be used. The objective of such systems is to optimally combine the information on the motion of the vehicle to estimate the position of the vehicle based on a known position at a previous time. Such systems are being introduced for the purpose of providing in-vehicle navigation service to the driver, including driving directions. A vehicle or portable device using a hybrid navigation system may be able to maintain a satisfactory estimate of geographic position, speed and azimuth throughout a period of time where the GPS signal is degraded or absent.

When a vehicle has a hybrid navigation system, the position estimate at the vehicle is usually better and more complete and reliable than systems where only GPS positioning is available. At present, hybrid navigation systems are generally only available in equipped vehicles and not in individual cellular telephones, although a cellular telephone so equipped is not precluded. In view of the relatively small population of users, the PDE entities may only implement request messages related to GPS pseudo-range position determination. In a circumstance where the hybrid system reports only the GPS pseudo-ranges as measured by a GPS receiver and not a geographical position estimate as made by the hybrid system, there may be instances where the vehicle location, although known with precision at the vehicle, may not be well estimated by the PDE on the basis of GPS pseudo-range data alone. The PDE may not be able to estimate the position of the vehicle at all if there are no GPS satellite signals being received by the vehicle at the time the request message was received.

The terminology associated with the GPS system is well established and contained in publication ICD-GPS-200C and other popular texts. With respect to navigation systems, there is no current equivalent, and the terminology utilized herein should be interpreted in accordance with the specification, unless otherwise indicated.

### BRIEF DESCRIPTION OF THE DRAWINGS

FIG. 1 illustrates the relationship between elements in a network where vehicle position determination is needed;

FIG. 2 illustrates the relationship of global positioning system (GPS) satellites and a GPS receiver located on the surface of the earth;

FIG. 3 is a block diagram of a navigation computer and related vehicular components in an example;

FIG. 4 is a top level flow diagram for the method of responding to a request for position determination information received by a vehicular unit; and

FIG. 5 is a detailed flow diagram for step 530, computing information for response.

Exemplary embodiments may be better understood with reference to the drawings, but these examples are not intended to be of a limiting nature. Like numbered elements in the same or different drawings perform equivalent functions.

### DETAILED DESCRIPTION

In an embodiment of the present invention, a vehicle having a hybrid navigation system responds to a request for GPS pseudo-range and related navigation data with either measured values of GPS pseudo-range data, a combination of measured GPS pseudo-range data and computed pseudo-range data, or entirely with computed pseudo-range data. Ancillary data which may be expected or required by the PDE may also be provided. The ancillary data may be in the form of estimates of position error, Doppler shift, heading, velocity and their associated error estimates, and the like, in order to provide a compatible data set to the PDE, representing the best position estimate of the vehicle at the time of transmission of the response.

The term “hybrid navigation system” may be also be described in the art as an “aided navigation system” and may include combinations of radio navigation, inertial navigation, and the use of non-inertial sensors such as an odometer or ABS. The hybrid navigation system may include these elements directly, or interfaces thereto to receive data provided by the elements, and may also include, or share the use of, a computer which may have the appropriate attributes, such as a central processor, volatile and non-volatile memory, input-output circuitry and the like. The computer may be configured to execute stored-program computer readable instructions to perform the functions described herein.

FIG.1 illustrates a mobile station, such as a vehicle 10, being in communication with a cellular radio base station 12. The cellular radio base station serves as a relay between the mobile station 10, the PDE 14 and the 911 center 16. The means of transmission of data between the PDE, the cellular base station and the 911 center may be any of the means known in the art; the details of the protocols are not relevant to the operation of the mobile station 10. The mobile station or vehicle 10 is configured and programmed to respond to a message received by, for example, a mobile or portable communications device (e.g., cellular telephone) located in the vehicle 10, from the base station 12 requesting pseudo-range and related data. Generally, pseudo-ranges are distances, but the data format may vary depending on the system and usage, and could be in the form of time, either absolute or relative, where the conversion between distance and time is the speed of light in a vacuum, or in terms of system properties, such as chips and fractional chips.

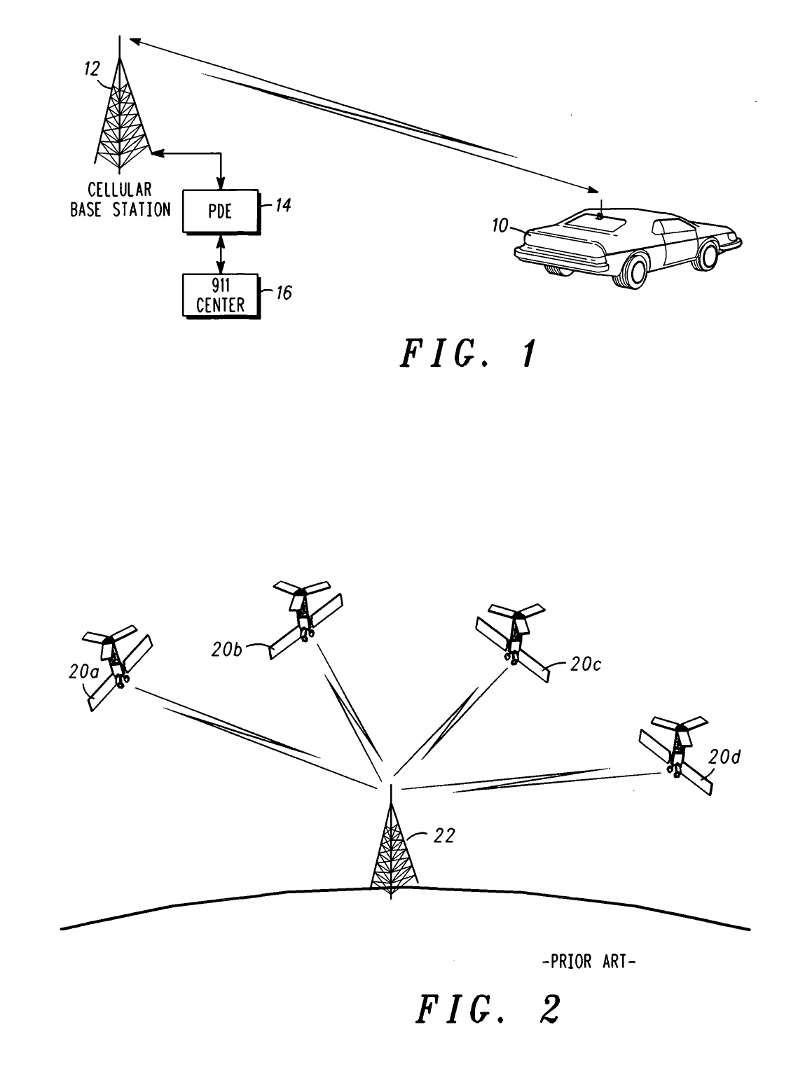

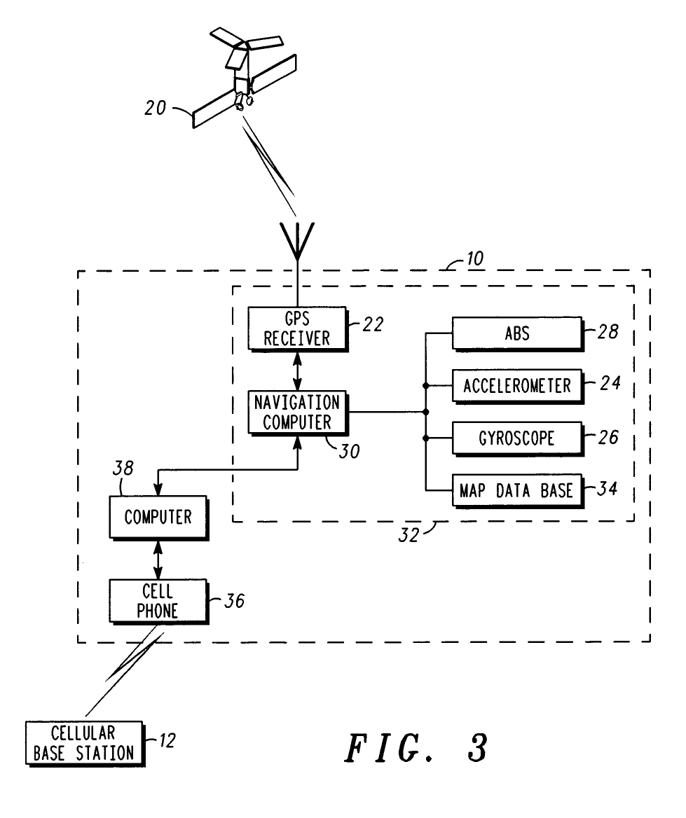

FIG. 2 illustrates a known satellite-based navigation system, such as GPS, where the current geographic location of a receiver 22 may be determined by measuring ranges to a number of GPS satellites (e.g., 20a, 20b, 20c, 20d) which are in earth orbit. The range to each satellite defines the radius of a sphere upon which the vehicle must lie, and the intersection of three or more such spheres uniquely determines the position of the receiver 22, at least where the receiver 22 is near the earth's surface. In practice, a fourth satellite is needed to determine a receiver clock offset value. Other information, such as the Doppler shift of each of the received frequencies and both the vehicle speed and azimuth may be determined.

Each GPS satellite 20 transmits ranging information in the form of a pseudo-random code sequence (PRN) characteristic of the particular satellite, as well as a navigation data message containing ephemeris data and almanac data which can be used to determine the position of the satellite in space at any time epoch. The ephemeris data relates to the specific satellite transmitting the data and constitutes the most accurate near-term estimate of the orbital parameters. Each of the satellites also transmits almanac data, which is pertinent to all of the satellites in the navigation constellation and has longer term validity. Among the functions performed by the ephemeris is enabling more rapid re-acquisition of a satellite if reception is interrupted, and permitting the most accurate estimation of the position of the satellite in space. The almanac provides assistance in acquiring satellites which have not been received for a period of time exceeding the validity of the ephemeris data. In some PDE configurations, the mobile station may be able to request almanac and ephemeris data from the PDE 14. Other aiding information such as the navigation message may also be available.

FIG. 3 illustrates an example of a generic hybrid vehicle navigation system 32, which may comprise sensors such as a GPS receiver 22, and one or more of, for example, a magnetic compass (not shown), an accelerometer 22, a gyroscope 26, outputs from an ABS 28, an odometer or equivalent measure of distance traveled or speed (not shown), and a navigation computer 30 to receive data from the sensors and combine the data to compute an estimate of the vehicle geographic position, and possibly the vehicle velocity and azimuth. In addition to the sensors, some systems may also utilize a map database 34 of roadways stored on a computer readable medium, such that the computed position of the vehicle is adjusted by the known roadway locations as another input to the overall process of computing the vehicle location. For this example, the specific configuration of the hybrid navigation system is not significant. The use of a hybrid navigation system permits the vehicle geo-location to continue to be estimated even when a sufficient number of GPS satellite signals cannot be received.

FIG. 3 further illustrates the relationship of the hybrid navigation system 32 to the vehicle 10, the cellular telephone 36 or other mobile communications device, and the computer 38 for responding to the PDE request. In addition to the GPS receiver 22, the individual sensors, such as the ABS 28 and the gyroscope 26 may be connected to the navigation computer 30 directly or through a vehicular data bus. Similarly, the map database 34 can be accessed by the navigation computer 30 to provide information on the location, orientation, and other properties, such as direction of roads, in the vicinity of the currently computed geographic location.

The navigation computer 30 may interface with a vehicular computer 38 that may serve to interpret the messages received from the cellular system base station 12 and obtain the required response information from the navigation computer 30. The communications link is shown as being between a cellular base station 12 and the cellular telephone 36, however the same function can be performed by a transmitter and receiver at the vehicle, and a corresponding capability at a remote location. Alternatively, the computer 38 may be combined with a navigation computer 30 in the hybrid navigation system 32 or in the cellular telephone 36 to perform the functions described.

In the situation where a request for location determination data is received from a PDE 14 or, alternatively, initiated autonomously at the vehicle, the computer 38 formulates one or more response messages in accordance with an established protocol. In this example, the messages may be in accordance with a subset of the TIA/EIA/IS-801 specification.

There are a variety of methods which may be selected to formulate response message(s), several of which are described. It will understood that other combinations and extensions of these methods may be used, depending on the specific hybrid navigation system being used, the availability of GPS signals at the time of formulating the response, and the estimated accuracy of the vehicle geographic location achieved or desired.

If a sufficient number of GPS satellite signals are currently being received, the position and ancillary data may be computed from GPS alone, as is currently the practice, and used for the response message. In general, the hybrid navigation solution will be both more accurate and available than the GPS solution alone, and providing the more accurate geographic location information to a PDE would benefit the emergency services and the vehicle operator. The information provided by the vehicle, portable or mobile unit will have greater utility if provided in a prescribed format, and formulated to take into account the analysis and interpretation methods of the PDE.

For example, if the PDE requests information in the form of GPS pseudo-ranges, the vehicle may provide information in that format. In the situation where GPS pseudo-ranges and related data are needed for inclusion in the response, actual GPS measured pseudo-ranges, or computed GPS pseudo-ranges or a combination of the two may be used.

Where computed GPS pseudo-ranges are desired, they may be computed by geometry, although certain adjustments to the computation may be made to account for radio propagation phenomena. The location of each GPS satellite 20 in orbit is characterized by data contained in the ephemeris. With knowledge of the GPS clock time, which may be obtained from any of the GPS satellites 20 which has been received in the recent past, the position of each of the GPS satellites in space may be determined for a particular time. To an approximation, radio waves propagate in a straight line, so that the distance between each satellite and the vehicle may be computed by geometrical means, where the latitude, longitude and height of the vehicle (geographic location) are presumed to be known as estimates provided by the hybrid navigation system. Other related data, such as the Doppler shift of the signal from each GPS satellite may also be computed.

The pseudo-ranges thus computed are not fully representative of the data expected by the PDE as the actual pseudo-range data obtained from a GPS satellite has additional delay components (equivalent to increased path length) associated with propagation of the radio signal through layers of the earth's atmosphere, such as the ionosphere and the troposphere. The additional delay components result from the change in propagation velocity of the radio wave when passing through the ionosphere and the troposphere, where the refractive index differs from that in the vacuum of space. A difference results between the geometrical distance and that computed using the actual propagation velocity along the path. The additional delay components are most evident for line-of-sight paths to the satellite and the vehicle which are near the earth horizon as viewed from the GPS receiver. These additional delay components are well known and usually represented by mathematical models, and a PDE 14 will interpret pseudo-range data supplied by the vehicle by calculating the additional delay components using an algorithmic model, and correcting the measured GPS pseudo-ranges accordingly. Alternatively, the additional delay components represented in the pseudo-range may be measured at the PDE 14 or other location rather than being computed and, providing that the locations are sufficiently representative of the area of coverage, the measurements may be used to correct the reported pseudo-ranges.

Since the corrections are made at the PDE 14 on the data received from the vehicle, the data supplied by the vehicle response message should have the additional delay components added to the computed pseudo range.

The locations in space (X, Y, Z) of all of the satellites are known, including those for which the transmission path between the satellite 20 and a particular GPS receiver 22 are blocked by the earth and it would be, in principle, possible to supply a pseudo-range and Doppler value for each satellite 20 to the PDE 14. This is not necessary so long as a sufficient number of pseudo-ranges are supplied to the PDE 14 for the computation of geographic location to proceed.

At any time, there exist advantageous selections of pseudo-ranges from the totality of pseudo-ranges which may be measured, associated with geometrical considerations. This is termed geometrical dilution of precision (GDOP) and relates to the spatial distribution of satellites capable of being received. Satellites capable of being received at any specific time by a receiver in an unobstructed environment are termed “in view”. An alternative term to “in view” is “above the horizon”. In order to minimize the propagation effects previously described, and the effects of reflections from nearby objects, the receiver may be programmed to ignore signals from satellites whose line-of-sight path is less than a specified number of degrees above the geometrical horizon; this is termed the masking angle. A selection of satellites in view resulting in an advantageous GDOP may be determined, and the spatial position of the selected satellites used to compute the set of pseudo-ranges and related data to be sent to the PDE 14.

Although the satellites not in view may also have pseudo-ranges computed with respect to the geo-location of the vehicle, the propagation effect corrections may be difficult to simulate as the angles would be out of the ranges expected by the models. However, in the event that the algorithms at a PDE 14 accommodate this situation, pseudo-ranges for satellites not in view may also be supplied.

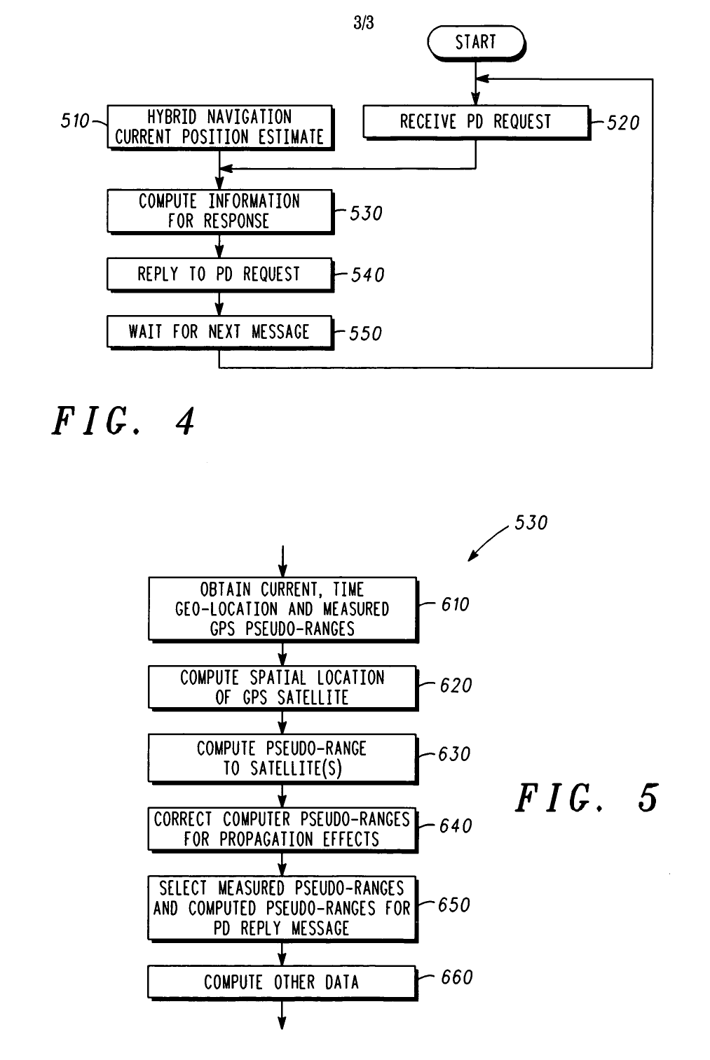

In another embodiment, the hybrid navigation system may have position update data supplied by a source other than GPS. For example, in a building, wireless connections may be capable of supplying information as to the physical location thereof, and if the transmissions permit sufficiently accurate localization of the vehicle, this may be used to update the estimate of position. Providing that clock time and the GPS satellite parameters are available, pseudo-ranges may be computed even if there is no GPS receiver associated with the hybrid navigation system 32, or the GPS signals have been blocked for a considerable period of time. Short-distance wireless links, such as Bluetooth or other short distance radio protocols, may provide the vehicle localization. Where the term “vehicle” is used, it should be understood that the intent is to include any mobile or portable electronic device associated with a specific location at a particular time, which may be entirely contained in a cellular telephone, or a portable phone intended to be used in a local environment. Moreover, such a hybrid navigation system may depend on the short distance radio protocol for all aspects of the localization of the vehicle, except that GPS satellite parameters, propagation corrections, and perhaps clock time, needed to compute pseudo-ranges, in lieu of measured pseudo-ranges, may be obtained from another source such as the cellular telephone 36 or through the short distance radio protocol. Thus, computed GPS pseudo-ranges may be supplied to a PDE 14 even in the situation where the vehicle does not have an associated GPS receiver. FIG. 4 illustrates the flow chart of a method of providing vehicle position determination information to a remote requestor that includes: step 510, operating a hybrid navigation system to produce an estimate of the current vehicle position; step 520, receiving a message requesting vehicle position determination information; step 530, determining vehicle positioning information needed to respond to the requesting message based on the estimate of vehicle position and other parameters provided by the hybrid navigation system; and, step 540, responding to the requesting message with a reply message.

The step 510 of operating a hybrid navigation system may include receiving GPS satellite signals when they are available, determining measured pseudo-ranges and computing a navigation solution having at least a geographic location component; combining the geo-location or pseudo-range data with other navigation-related information, which may include one or more of angular rate data, acceleration data, magnetic heading data, steering direction data, speed data, distance data or map data. The angular rate data may be obtained from a gyroscope, or differential ABS data; the acceleration data may be obtained from one or more accelerometers, or by differentiating the speed or distance data; the magnetic heading data may be obtained from a magnetic compass or flux-gate magnetometer, or the like; and the speed data and the distance data may be obtained from the ABS or from an odometer. The map data may be obtained from a database stored on the vehicle, or equivalent data received over a data link or through the cellular telephone 36, which has the effect of establishing constraints on the position of the vehicle based on geographical location of roadways, including permitted directions of motion. The difference between the closest allowed position and the current estimate of position may be used as an error component input to the hybrid navigation system.

The step of operating the hybrid navigation system may further include the combination of the GPS data or geographic location data with any one or more of the additional navigation data sources in a hybrid position determining algorithm. The hybrid position determination algorithm may be a least-mean-squares estimator or a Kalman filter as is known in the art, although other algorithms may be used.

As shown in FIG. 5, the step 530 of determining the vehicle positioning information necessary to respond to the request message may include: step 610, determining the current time; step 620, locating the spatial position of GPS satellites based on known ephemeris information; step 630 computing the range between the vehicle geo-location and a plurality of GPS satellites; step 640, correcting the computed pseudo-ranges to add ionospheric and troposhperic errors so that the computed ranges are an estimate of pseudo-ranges which would have been measured by a GPS receiver; step 650, selecting some of all of the measured GPS pseudo-ranges and the computed pseudo-ranges to be included in the reply message; and step 660, determining additional information which may be required to respond to the request message. The additional information may include, for example, Doppler shift for each reported pseudo-range, estimated location accuracy, GDOP, azimuth of motion, velocity of motion, and the estimated accuracy thereof.

The step of responding to the request message may include formatting a response message in accordance with a known data protocol to include the vehicle geographic location information and other status information, and providing the information to a system component for transmission to the PDE.

Although the method has been described in a manner where all of the pseudo-ranges may have been computed based on the vehicle geographic location as determined by the hybrid navigation system, this is not meant to exclude the use of measured GPS pseudo-ranges and other GPS data which may be measurable at the time the geographic location is being computed or the response to the request message is being assembled. A combination of computed and measured data may be used where, for example, measured GPS data are used for some or all of the satellites which are currently being received, and computed pseudo-range data for satellites which may be in view in an unobstructed environment, but are not being received for some reason such as signal blockage, or may be below a cut-off horizon. As has been mentioned, data relating to satellites below the viewing horizon may be used providing that the PDE is configured to properly process such data. When combining measured and computed pseudo-ranges in a response, the pseudo-range which is computed by geometrical considerations is adjusted so that it appears to have the same clock offset as that of the measured GPS pseudo-ranges so that a consistent data set is provided to the PDE.

In another embodiment, the geographic location output of the hybrid navigation system and the associated navigation data may be reported in response to a message that requests geographic location data rather than data in pseudo-range format. Such data can be in the form, for example, of latitude, longitude and height above the geoid or other datum. Such data may be supplied in place of the GPS-derived geographic location data either at all times, or when the GPS data is not currently available. The geographic location and accuracy estimate thereof may be based on the hybrid navigation system state estimate, and be formulated so as to appear to be estimated based on GPS.

In yet another embodiment, a message reporting geographic location information in any allowable format may be initiated in response to an event occurring at the vehicle, without the necessity for a request message from the PDE. This may be the situation where, for example, an accident occurs, or a user presses a panic button, including a panic button which may be in communication with the vehicle equipment.

In a further embodiment, the hybrid navigation system may request aiding information from the PDE, and such aiding information may include current time and ephemeris data in the situation where the vehicle has not been able to receive the GPS satellites for some time, such as having been parked in an underground garage. Rapid acquisition of current ephemeris data will permit the rapid computation of accurate pseudo-ranges prior to re-acquisition of the GPS signals, and expedite the acquisition of GPS signals by reducing the searching time.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A vehicle position location apparatus comprising:
an aiding data source; and
a computer configured to execute a stored software program to perform vehicle position estimation,
wherein a first output signal of the computer comprises at least one computed pseudo-range to a global positioning system (GPS) satellite.

2. The apparatus of claim 1, further comprising a hybrid navigation system.

3. The apparatus of claim 1, further comprising a GPS receiver.

4. The apparatus of claim 3, wherein the computed pseudo-range includes a correction for estimated radio frequency propagation delay along the path between the GPS receiver and the GPS satellite.

5. The apparatus of claim 1, wherein the aiding data source includes at least one of an odometer, an automatic breaking system, a gyroscope, a magnetic compass, an accelerometer, a terrestrial radio-location system, a short-distance radio link, or a map database.

6. The apparatus of claim 2, wherein a second output signal includes at least one measured GPS pseudo-range, and the first output signal is adjusted to have a same clock offset as determined from the measured pseudo-range.

7. The apparatus of claim 2, wherein a second output signal includes at least one measured GPS pseudo-range, and the second output signal is adjusted to have a same clock offset as determined from the computed pseudo-range.

8. The apparatus of claim 1, where a third output comprises at least one of vehicle heading, vehicle speed, geometrical dilution of precision; position, velocity or azimuth error estimates; Doppler shift, or pseudo-range rate.

9. A method of providing vehicle position determination information, the method comprising:
receiving aiding data;
computing a vehicle geographic location;
computing a pseudo-range between a global positioning system (GPS) satellite and the vehicle; and
providing the computed pseudo-range to a requesting system.

10. The method of claim 9, further comprising receiving a GPS signal.

11. The method of claim 9, wherein the requesting system comprises a position determination entity (PDE).

12. The method of claim 9, wherein the requesting system is a safety system associated with the vehicle.

13. The method of claim 12, wherein the safety system comprises a panic button.

14. A method of determining the position of a vehicle, the method comprising:
receiving a request to perform position determination (PD);
sending a PD request message to a vehicle;
receiving a response message from the vehicle, the response message including a computed pseudo-range;
receiving and interpreting the response message;
computing the position of the vehicle from data contained in the response message, including the computed pseudo-range; and
responding to the request to perform PD.

15. The method of claim 14, wherein the request to perform PD originates at a 911 call center or at a vehicle safety system.
